(19) United States
(12) Patent Application Publication
(10) Pub. No.: US 2026/0366593 A1
(43) Pub. Date: Nov. 19, 2026

(54) ACTIVE MECHANICAL VALVE FOR SHOCK ABSORBERS

(71) Applicant: Vit Prosek, Plzen (CZ)

(72) Inventor: Vit Prosek, Plzen (CZ)

(21) Appl. No.: 19/501,263

(22) PCT Filed: Jul. 13, 2023
(86) PCT No.: PCT/CZ2023/050042

§ 371 Date: Jan. 12, 2026

(51) Int. Cl. F16F 9/504

(52) U.S. Cl. CPC F16F 9/504

(57) ABSTRACT

Active mechanical valve for shock absorbers used i.e., as compression valve in automotive or mountain bike shock absorber, which changes its properties in real time on mechanical principle. In other words: travel sensitive, speed regressive inertial valve. It comprises static member (10) and main member (12) being slidable with respect to static member (10). They are adapted for controlling primary restriction (19). The main member (12) is controllable at least by force of preloading member acting in the closing direction of primary restriction (19). Interspace (44) is adapted for communication with working chamber (9) of shock absorber (2). Primary restriction (19) is openable gap on interface between static member (10) and main member (12) on first end of interspace (44) and sliding fit (18) is on second end of interspace (44). Effective cross-sectional areas of sliding fit (18) and primary restriction (19 ) are different and thus form annulus (21).

### RELATED APPLICATION

This application is a national stage application under 35 U.S.C. § 371 of International Application No. PCT/CZ2023/050042, filed 13 Jul. 2023, the disclosure of which is hereby incorporated by reference into the present application in its entirety.

### FIELD OF TECHNOLOGY

Shock absorbers, which are part of the suspension of vehicles, motorcycles and especially bicycles. More specifically, the invention relates to valve arrangement in fluid shock absorbers.

### BACKGROUND OF THE INVENTION

Vehicle suspension must deal with various types of surface irregularities, thus reducing dynamic forces on the vehicle while improving wheel adhesion to the surface.

The shock absorber's task is to dampen unnecessary movements of the suspension. These are, for example, oscillations in the suspension's own frequency, wheels bouncing off the surface, tilting of vehicles, or bobbing of a suspended bicycle when pedaling. At the same time, the shock absorber should not be too stiff, to reduce driving comfort and contribute to driver's fatigue, or increase the vehicle's rolling resistance when driving over uneven terrain.

Current shock absorbers are using a restriction of the damping fluid flow, which is different during expansion and compression. There are often two channels in the compression direction. One uses orifice restriction in a limited flow cross-section for slow motions. The second one uses a pressure relief valve with shim stack for fast movements of the shock absorber. In this way, a degressive characteristic of the damping force to stroke speed can be created.

Some manufacturers have developed a valve with a regressive characteristic, which is even more advantageous for e.g., bicycles. This is achieved by spring-preloaded part, which closes oil ports of some area. Damping fluid creates an opening force by low flow rate, i.e., a large pressure drop is needed to open the valve. With a larger flow rate, a secondary restriction on the same component manifests. The secondary pressure-drop acts on a larger area and thus a lower primary pressure-drop is sufficient to keep the valve opened. However, the rate of regression is limited by the ratio of the size of the mentioned areas, which is limited in the current arrangement of the state of the art and cannot be increased further due to emerging excessive passive flow restriction.

Another way to improve the properties of the shock absorber is to distinguish, whether the movement of the shock absorber occurs due to the unevenness of the terrain or not. And this is provided by the inertial element, which is located on the unsprung mass. However, so that this inertial element does not have to be disproportionately massive in the current state of the art, it only opens additional parallel flow channels passively, without being affected by a pressure drop. The pitfall of this solution is that the acceleration from the terrain, which opens the flow channel thanks to the inertial element, has a very short-term effect. At the moment when the wheel is still rolling up on the obstacle, the unsprung mass is already accelerating in the opposite direction and this opened channel can be closed uncontrollably.

Modern way, how to enhance the shock absorber characteristics, is to use electronical control of valves, which brings extra costs, weight, and complexity.

### SUMMARY OF THE INVENTION

The essence of the invention is for example a compression valve of a shock absorber, working with a fluid. When mounted in the shock absorber, by compression stroke and corresponding fluid flow direction, the said valve is opened by pressure difference between the working (compression) chamber and expansion chamber (in case of bottom valve) or rebound chamber (in case of main valve of the shock absorber). Chambers are separated by a static member of the said valve, where ports allow the fluid to flow from working (compression) chamber into an interspace between the static member and a slidable main member of the said valve. The said pressure difference acts on a very thin annulus of the main member, created between the primary restriction and a sliding fit of slightly different diameters, which enables its axial movement without a seal resistance. Leakage through the sliding fit should freely flow away. In other words, the interspace is connected with the working chamber and located between the primary restriction and the sliding fit between the main member and the static member. When the main member is moved away from its end stop interface at the static member, the primary restriction is opened, large enough to not resist the fluid flow even at high speeds of the shock absorber stroke. Thanks to this, it is possible to control a preload of the main member towards the static member, which is primarily created by a mechanical spring or an air spring, with a very small force.

Furthermore, there can be also an additional port, parallel to the primary restriction, where a fluid flow is enabled especially by low speeds of the shock absorber stroke before the main member opens the primary restriction. This parallel port can be either an orifice in the static member, or in the main member, or a groove or gap in the interface between the main member and the static member.

The static member also provides a first check valve, where, by extension of the shock absorber, flows the fluid through ports parallel to the primary restriction. They can connect the compression chamber with the expansion chamber directly, or through a secondary restriction of the said valve.

In case of placement of the said valve at the piston as a main valve, there can be a first flexible shim instead of first check valve in the static member, which is axially preloaded by the static member and acts as a pressure relief valve for both flow directions.

Said preload of the main member can be controlled also by an acceleration of an unsprung mass of a vehicle without having to be disproportionately massive. And that either directly, when the main member itself forms an inertial element, either as a whole or separated, or indirectly, when the inertial element is located externally from shock absorber and with the help of a first hydraulic hose with fluid and membranes is its force brought to the main member, again without seal resistance.

To ensure such function, the inertial element or the main member itself has to be connected or attached to the unsprung mass of the vehicle and oriented in approximate direction, where, according to kinematics, acts the acceleration when crossing an obstacle. For purposes of this text is so-called positive acceleration caused by increased contact force between wheel and the obstacle at the time of their first contact and moves the wheel up. Whilst so-called negative acceleration is caused by suspension force, when the upward movement is slowed down as the wheel approaches the top of the obstacle, or when the contact between wheel and terrain is lost. By the positive acceleration is the inertial force directly or indirectly acting on the main member in opening direction of the primary restriction, against the said preload.

Furthermore, said preload of the main member can be controlled by a force from a pressure drop caused by in-series-arranged secondary restriction, which acts against the said preload. Said pressure drop acts on a many times larger area (i.e., 5× . . . 1000×) of the main member assembly members than the thin annulus, where the primary restriction acts. To open the primary restriction, the secondary restriction requires a relatively small pressure drop, which affects the total resistance of the said valve almost imperceptibly or only about a predefined value.

The secondary restriction may have two stages-high-speed and low-speed. The low-speed secondary restriction is further described as secondary restriction only.

The secondary restriction may have its own pressure relief valve, which can limit the maximal force created by it.

The secondary restriction may have its own second check valve, to facilitate the fluid flow in opposite direction i.e., by opening movement of the main member, or by extension of the shock absorber.

The secondary restriction and a slidable inertial element can be arranged in that way that the inertial element under the negative acceleration changes the characteristic of the secondary restriction by opening additional ports in the main member, or a gap between them.

Both mentioned forces from the positive acceleration and from the pressure drop on the secondary restriction (indirectly from the stroke speed) acts in the opposite direction to the preloading force of the main member, and therefore reduces the pressure drop at the primary restriction needed to open the said valve. The said valve can be completely opened before the compression stroke of the shock absorber occurs, or on the contrary, can close itself when the wheel loses its contact with the terrain.

Said air pressure spring is formed by a flexible membrane between the slidable main member and the static member. The flexible membrane closes an air chamber with atmospheric pressure between these two parts without seal resistance. To create a force, it uses a gas pressure in the expansion chamber, which must also be formed by a flexible membrane, again without the resistance of any seal. The pressure in the expansion chamber increases exponentially with the stroke, thanks to that the damping can be dependent on the shock absorber stroke in addition to acceleration and speed.

If the static member is protruding through the main member, there need to be two flexible membranes with different effective diameters, which are creating the air spring chamber.

There is one more arrangement of the air spring possible, where alternative membranes are surrounding two parts which are slidable against each other and their interfaces with the membranes have different effective diameters on each side.

To prevent unwanted vibrations of the main member, the said valve can also contain a damping chamber between the main member and the static member, which pumps the fluid inwards and outwards when the main member is moved, created by a sliding interface with defined flow restriction. Said damping chamber can also contain a third check valve to facilitate the opening movement of the main member.

The said valve can be used as a bottom valve between compression chamber and expansion chamber or as a main valve between compression chamber and rebound chamber.

The said valve can be also used as a rebound valve to dampen the extension stroke of the shock absorber.

Such shock absorber properties are changing in real time on a purely mechanical principle.

For purposes of electrification of damping adjustment, the main member could be directly preloaded and controlled by electromagnetic field which can exert a force in opening or closing direction of primary restriction. This force can be also only a supplement to force of the spring preloading the main member.

Shock absorber force during compression stroke (simplified):

F_{absorber}=Δ_{p.rod}×p_{comp.chamber}+(A_{cyl.}−A_{p.rod})×Δpₚᵢₛₜₒₙ
Where in case of using the compression valve as a bottom valve:

p_{comp.chamber}=p_{exp.chamber}+Δp_{sek.restr.}+Δp_{prim.restr.}
Where in case of using the compression valve as a main valve:

p_{comp.chamber}=p_{exp.chamber}

Δpₚᵢₛₜₒₙ=Δp_{sek.restr.}+Δp_{prim.restr.}

Forces at the main member of the compression valve (simplified):

F_{preload}=Fₐ+Fᵥ+Fₚ

_{preload}=m_{elem.}×a_{unspr.mass}+Δp_{sek.restr.}×A_{elem.}+Δp_{prim.restr.}×(A_{prim.restr.}−A_{slid.fit})

### Eventually:

F_{air spr.}=Fₐ+Fᵥ+Fₚ+F_{neg.spr.}

A_{air spr.}×(p_{exp.chamber}−p_{spr.chamber})=m_{elem.}×a_{unspr.mass}+Δp_{sek.restr.}×A_{elem.}

+Δp_{prim.restr.}×(A_{prim.restr.}−A_{slid.fit})+F_{neg.spr.}

### BRIEF DESCRIPTION OF THE DRAWINGS

FIG. 1: An alternative of using the valve in a shock absorber of a fork, where there is an open bath system inside the structural parts. The main member and the inertial element are split. The secondary restriction with the pressure relief valve is located on the inertial element. The mechanical and the air spring work together.

FIG. 2a: An alternative of using the valve in a shock absorber with an inner expansion chamber which is formed by a plug with a seal. The main member is also an inertial element. The secondary restriction includes the pressure relief valve and the second check valve. Preload of the mechanical spring is externally adjustable.

FIG. 2b: Same as FIG. 2a, wherein the secondary restriction is depicted with the pressure relief valve active state.

FIG. 2c: Same as FIG. 2a, where the secondary restriction is depicted with the second check valve active state.

FIG. 3a: An alternative of using the valve in a shock absorber with an inner expansion chamber which is formed by a membrane. The main member is also an inertial element. The secondary restriction consists of the pressure relief valve as well as the second check valve, all integrated in a single piece. The pressure in the expansion chamber and thus the preload of the air spring is externally adjustable.

FIG. 3b: Same as FIG. 3a, where the secondary restriction is depicted with the pressure relief valve active state.

FIG. 3c: Same as FIG. 3a, where the secondary restriction is depicted with the second check valve active state.

FIG. 4a: An alternative of using the valve in a shock absorber with an expansion chamber created by a membrane outside and around the shock absorber. The main member and the inertial element are split so that the inertial element can temporarily reduce the secondary restriction. The secondary restriction is located at the main member. The initial state of the primary restriction gap is externally adjustable.

FIG. 4b: Same as FIG. 4a, where the inertial element is depicted with the temporary reduction of secondary restriction state.

FIG. 5a: An alternative of using the valve in a shock absorber with an expansion chamber created by a membrane outside and around the shock absorber. The main member and the inertial element are split. The secondary restriction with the pressure relief valve is located at the main member. Preload of the pressure relief valve of the secondary restriction is externally adjustable.

FIG. 5b: Same as FIG. 5a, where the secondary restriction is depicted with the pressure relief valve active state and inertial element's negative force limited.

FIG. 6: Same as FIG. 3a, where the valve is located in an external container, connected to the shock absorber by a second hydraulic hose. The expansion chamber, formed by a membrane, is inside the external container.

FIG. 7: An alternative of using the valve outside the shock absorber cylinder, in the part with the expansion chamber. The external inertial element is connected by a first hydraulic hose. The secondary restriction contains the pressure relief valve. The first check valve is located parallel to the secondary restriction. Preload of the negative spring is externally adjustable.

FIG. 8: An alternative of using the valve outside the shock absorber cylinder, in the part with the expansion chamber. The external inertial element is connected by a first hydraulic hose. The secondary restriction contains the pressure relief valve and the second check valve. The first check valve is located serially to the secondary restriction. Preload of the negative spring is externally adjustable.

FIG. 9: An alternative of using the valve in a shock absorber as a main valve with an expansion chamber inside, which is formed by a plug with a seal. The main member is also an inertial element. The secondary restriction is formed by a gap around the main member, the pressure relief valve is included separately. Preload of the mechanical spring is externally adjustable and adjusts both, the main member preload and the secondary restriction pressure relief valve at once.

FIG. 10: An alternative of using the valve in a shock absorber as a main valve with an expansion chamber inside which is formed by a plug with a seal. The main member is also an inertial element. The secondary restriction is formed by a gap around a partition assembled to the main member which works as the pressure relief valve. Preload of the mechanical spring is externally adjustable and adjusts both, the main member preload and the secondary restriction pressure relief valve at once.

FIG. 11a: A graph showing the resistance of the shock absorber and the wheel contact force when crossing an obstacle at speed of 10 km/h. Time sequence logic is from left to right. Zero point is the top of the obstacle. On the left side, from zero, there is a compression stroke. On the right side, from zero, there is an extension stroke. At first, the shock absorber is very firm to resist the pedaling forces. By first contact with the obstacle, the shock absorber resistance is canceled thanks to the inertial element. Then, the shock absorber resistance is reduced thanks to the secondary restriction. Shortly before the zero, the compression stroke speed is slow enough so that the valve can gradually increase the shock absorber resistance.

FIG. 11b: A graph showing the forces from acceleration, speed and their resultant with preload acting on the main member, which creates the pressure drop of the primary restriction at speed of 10 km/h.

FIG. 12a: A graph showing the resistance of the shock absorber and the wheel contact force when crossing an obstacle at speed of 30 km/h. Behavior is very similar to 10 km/h, only the end phase of compression stoke is shorter. Note that the contact force is lower but still positive, hence there is no need for greater resistance of the shock absorber yet.

FIG. 12b: A graph showing the forces from acceleration, speed and their resultant with preload acting on the main member, which creates the pressure drop of the primary restriction at speed of 30 km/h.

FIG. 13a: A graph showing the resistance of the shock absorber and the wheel contact force when crossing an obstacle at speed of 50 km/h. Note that the contact force tends to be negative-contact with terrain is lost. Shock absorber resistance has increased in comparison to 30 km/h to prevent the contact loss. Towards the obstacle peak, the level of the shock absorber resistance is even higher than the initial setup was. The calculation does not reflect the stiffness of the tire so the first stage of the compression stroke could be softer in reality. With a right combination of the inertial element mass, the secondary restriction and a passive resistance of the whole valve, the contact with the terrain may be possibly held for the whole compression stroke.

FIG. 13b: A graph showing the forces from acceleration, speed and their resultant with preload acting on the main member which creates the pressure drop of the primary restriction at speed of 50 km/h.

FIG. 14a: A graph showing the resistance of the state-of-art shock absorber and the wheel contact force when crossing an obstacle at speed of 50 km/h without the effects of speed and acceleration. The contact force with the terrain is lower even with the same compression resistance setup. Such firm compression resistance would make such shock absorber inapplicable in lower speeds.

FIG. 14b: A graph showing the force from preload acting on the main member which creates the pressure drop of the primary restriction at speed of 50 km/h.

FIG. 15: A graph showing the regressive characteristic of the shock absorber using described valve depending on the speed of its movement.

FIG. 16: A graph showing the regressive characteristic of the shock absorber using described valve depending on the speed of its movement and influence of the acceleration. The active flow restriction is provided by the primary restriction and the passive flow restriction is provided by the secondary restriction and a passive resistance of the valve.

FIG. 17: A graph showing the degressive characteristic of the state of art shock absorber depending on the speed of its movement.

FIG. 18: A graph showing the resistance of the shock absorber when crossing an obstacle. State of the art is compared to the described solution.

### INDUSTRIAL APPLICABILITY

The valve can be used in shock absorbers of all types of vehicles, motorcycles and especially bicycles. Especially in the technical disciplines of mountain bikes where its exceptionally stiff characteristics are applied together with minimal resistance when crossing an obstacle.

Shock absorber resistance using described valve as a compression valve is during rolling over an obstacle inversed in comparison to current state-of-the-art shock absorbers. Its characteristic is focused on lower resistance when the contact force between wheel and terrain acts partially against the direction of the ride and on higher resistance when the contact force between wheel and terrain acts more upwards.

This approach could save up to 15% of energy needed to drive through rough terrain and simultaneously can enhance the adhesion at faster riding speed through rough terrain.

### DETAILED DESCRIPTION OF THE PREFERRED EMBODIMENTS

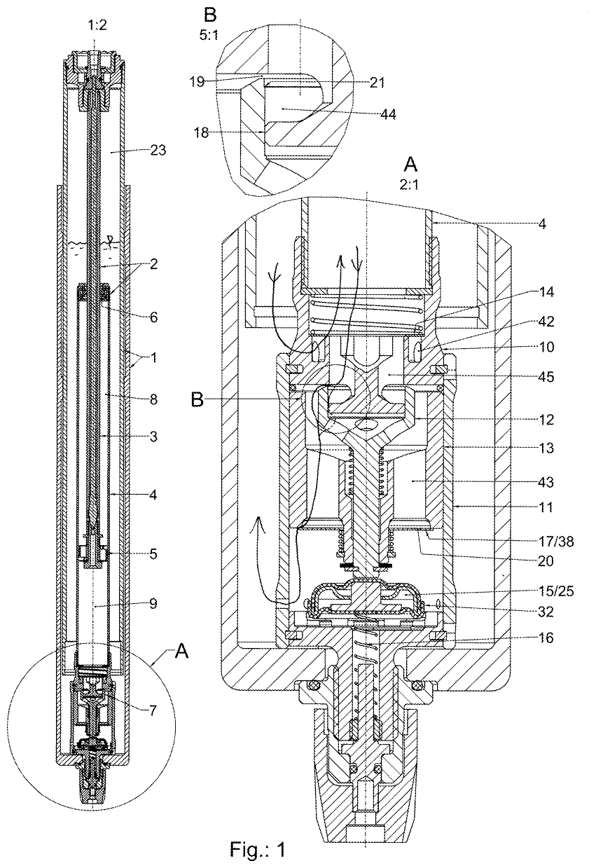

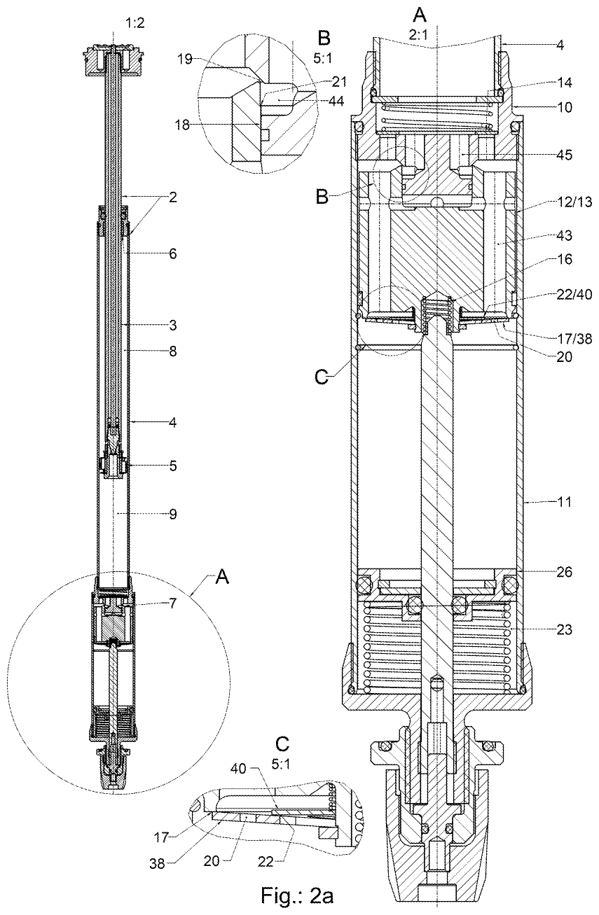

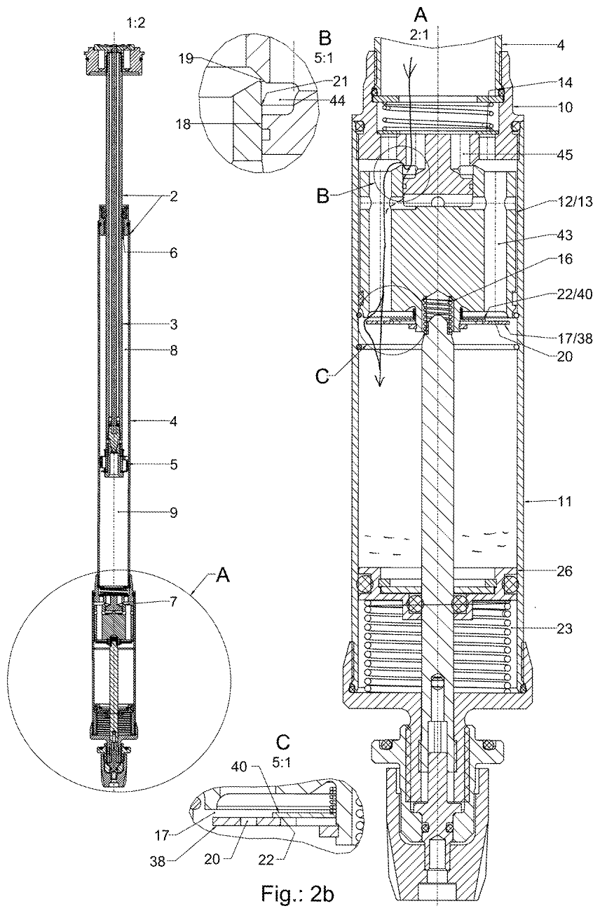

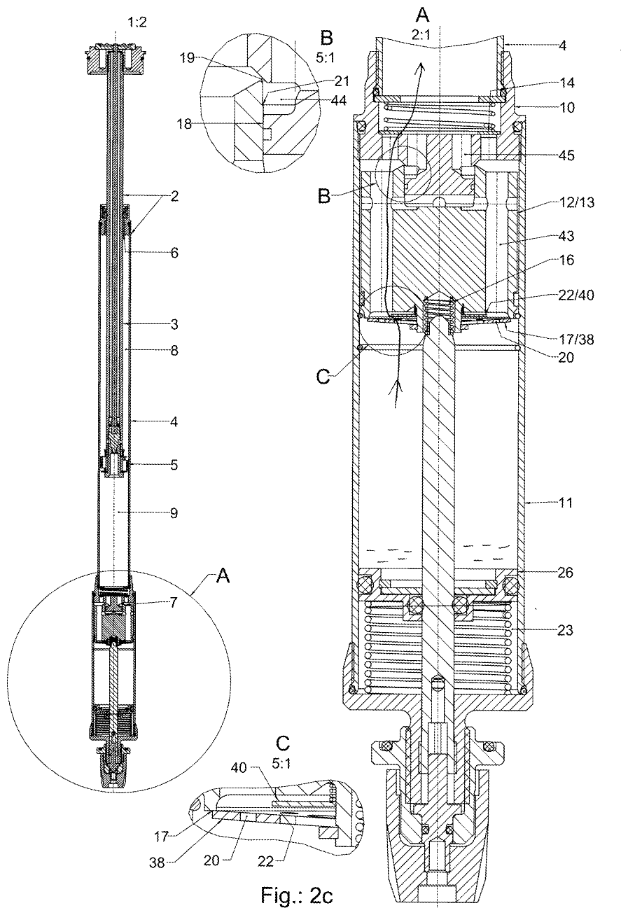

### FIG. 1:

The FIG. 1 shows similar arrangement of the shock absorber 2 as described by following figures with the following difference when compared to other embodiments.

Preload of the main member 12 towards the static member 10 is provided by a mechanical spring 16, which is externally adjustable, and by an air spring 15 which is formed by alternative membranes 32 surrounding one static and one movable part. Static part and movable part have contact areas to the alternative membranes 32 which are mutually different in size.

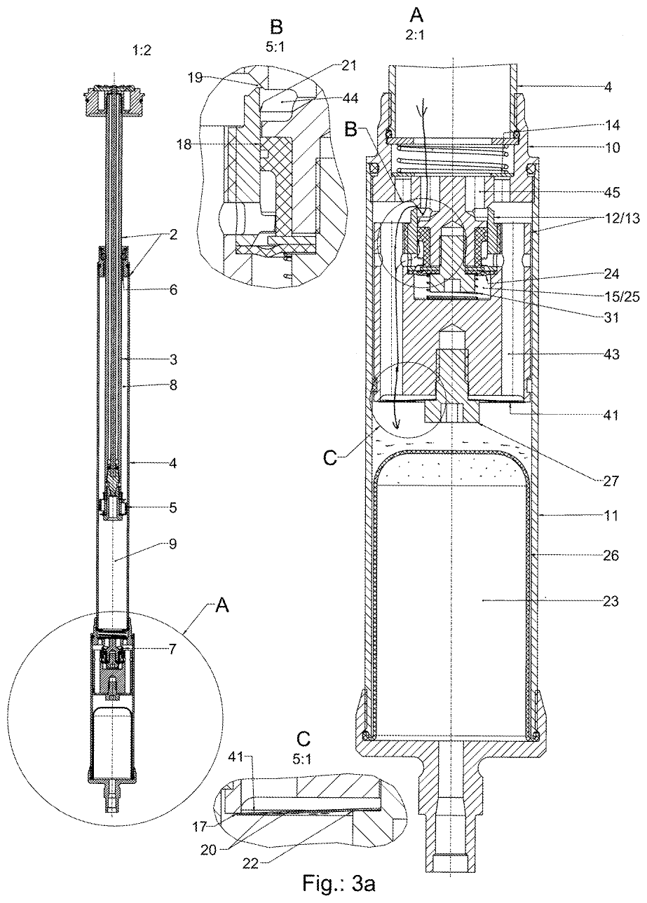

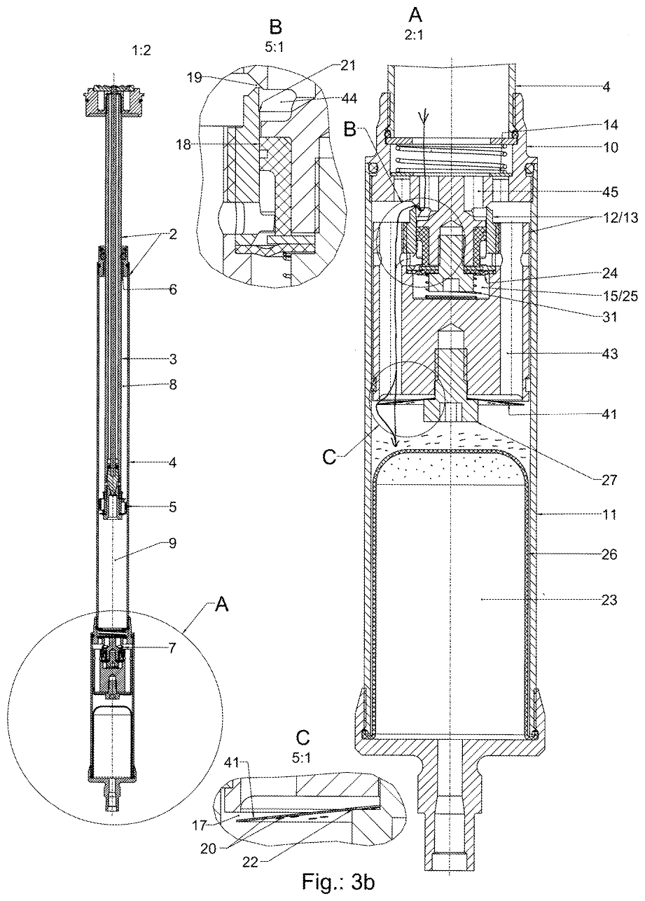

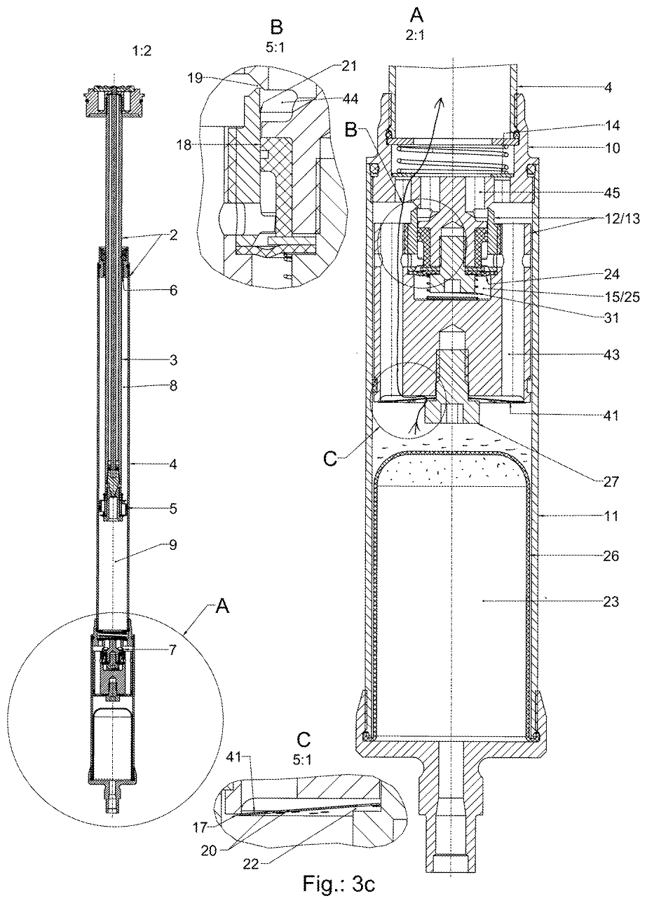

FIG. 3a-3c:

The FIG. 3a-3c show a shock absorber 2 which can work independently or, for example, inside the suspension fork of a bicycle. It includes a piston rod 3, a main cylinder 4, a piston 5, which forms the main valve, and the expansion chamber 23, in front of which is located the valve 7, working as a compression valve, so called bottom valve. The lower part of the shock absorber 2 with the valve 7 is part of the unsprung mass.

During the expansion movement of the shock absorber 2, the damping fluid is forced out from the rebound chamber 8 to the working (compression) chamber 9 through the main valve on the piston 5. The missing volume of the piston rod 3 in the working (compression) chamber 9 is subsidized from the expansion chamber 23 through the valve 7 where the damping fluid flows through the second check valve 22 of secondary restriction 20 and further through the first check valve 14 which bypasses the primary restriction 19.

During the compression stroke of the shock absorber 2, the damping fluid of the volume of the piston rod 3 is forced out of the working (compression) chamber 9 into the expansion chamber 23 through the valve 7. The remaining volume flows from the working (compression) chamber 9 to the rebound chamber 8 through a check valve on the piston 5.

During the compression stroke of the shock absorber 2, the first check valve 14 is closed. The damping fluid flows through a set of ports 45 in the static member 10 into an interspace 44 where it exerts pressure, among others, on the thin annulus 21 of the main member 12 which is slidable relatively to the static member 10.

From one side of said interspace 44, the fluid leakage is limited by a sliding fit “seal” 18 between the main member 12 and the static member 10. It may contain grooves or some sliding material. It is important that, even under the pressure of the damping fluid, it does not create resistance in the movement of the main member 12. A small amount of fluid that passes through this sliding fit “seal” 18 is led without resistance into the space between the primary restriction 19 and the secondary restriction 20.

From the other side of the said interspace 44, there is a primary restriction 19 formed by an interface or gap between the static member 10 and the main member 12. Its size varies depending on the relative position of these two components.

The diameter, at which the primary restriction 19 occurs, is slightly larger than the diameter of the sliding fit 18. Due to this, the pressure of the damping fluid creates a force on the main member 12. This force acts in the opening direction of the primary restriction 19 and is several times smaller than the force applied on the piston rod 3. Specifically, in the ratio of the cross-sectional area of the piston rod 3 to the area of the thin annulus 21 between the primary restriction 19 and the sliding fit 18. This is essential because the movements of the main member 12 can be controlled with very small forces. At the same time, the primary restriction 19 offers a sufficient flow cross-section in its open state. Even at high speeds of the shock absorber 2 stroke, it imposes minimal resistance to the damping fluid.

The main member 12 is preloaded by the air spring 15 which presses the main member 12 towards the static member 10 and thereby closes the primary restriction 19. The air spring 15 is formed by an air chamber 25 which comprises air at atmospheric pressure. The air chamber 25 is closed by a flexible membrane 24 between the static member 10 and the main member 12. Sealing is achieved by tightening the screw to the static member 10 and screwing together the main member 12 with the inertial element 13.

The force of the air spring 15 is created by the pressure difference in the expansion chamber 23 against the air chamber 25 multiplied by the effective diameter of the flexible membrane 24. Since the pressure in the expansion chamber 23 depends on the stroke of the shock absorber 2, the contact pressure of the main member 12 against the static member 10 also depends on the stroke of the shock absorber 2. Thus, also the pressure of the damping fluid required to open the primary restriction 19 depends on the stroke of the shock absorber 2 and finally also the damping force of shock absorber 2. The additional relief spring in the air chamber 25 acts against the force of the air spring 15 and allows a higher pressure to be set inside the shock absorber 2. Further, it can be used to reset the resistance of the shock absorber 2 in the initial phase of the compression stroke.

The expansion chamber 23 is formed by a flexible membrane 26. It is important that the change in the volume of the expansion chamber 23 does not create any resistance or hysteresis, as this would have a very negative effect on the force of the air spring 15.

The edge of the main member 12, which forms the primary restriction 19, may additionally contain grooves. The grooves will, together with the natural leakage of the sliding fit 18, create an increasing speed characteristic at very low speeds of the shock absorber 2 stroke until the moment when the force from the pressure drop on the primary restriction 19 exerted on the slidable main member 12 overcomes the preload of the air spring 15. Subsequently, the main member 12 moves away and opens the primary restriction 19 gap more.

Furthermore, all the damping fluid flows through the main member 12 (here it is also the inertial element 13) with a defined but small resistance of high-speed secondary restriction 43 made by bores in the inertial element 13 up to the secondary restriction 20. The pressure drop of the secondary restriction 20 acts on a several times larger area of the main member 12 and inertial element 13 assembly compared to the primary restriction 19. The pressure drop creates a force in the direction against the preload of the air spring 15. Thus, a relatively small pressure drop, with almost imperceptible resistance to the damping fluid, is sufficient to relieve or completely open the primary restriction 19.

The area on which the pressure drop of the secondary restriction 20 acts is defined by the annulus between the inner diameter of the valve cylinder 11 and effective diameter of the flexible membrane 24.

The secondary restriction 20 is created by a set of small holes in a second flexible shim 41 which is placed on the main member 12 and inertial element 13 assembly and preloaded with a screw. These holes are placed on a larger pitch circle than the screw head. As the speed of the compression stroke of the shock absorber 2 increases, the pressure drop on the secondary restriction 20 also increases. Therefore, the force acting against the preload of the said second flexible shim 41 as well as the force exerted on the main member 12 and inertial element 13 assembly, which help to open the primary restriction 19, also increase. Thereby the fluid pressure in working (compression) chamber 9 needed to open the primary restriction 19, as well as the resistance of the shock absorber 2, is decreasing. For use in bicycles, the resistance of the secondary restriction 20 should be low during stroke speeds corresponding to pedaling (so called pedal bob) and thus relieves the primary restriction 19 preload only a little. As a result, the resistance of the shock absorber 2 remains high. On the contrary, at stroke speeds corresponding to crossing the obstacles, the resistance of the secondary restriction 20 should already be sufficient to completely relieve the primary restriction 19 preload, so the resistance of the shock absorber 2 is minimal.

In order to be still sensitive to other influences even at higher stroke speeds, it is necessary to limit the maximum force of the secondary restriction 20 by its function of the pressure relief valve 17. The function of the pressure relief valve 17 occurs when the preload of the second flexible shim 41 is overcome by the pressure drop and it lifts away from the main member 12 and inertial element 13 assembly at its outer diameter.

In the opposite direction of shock absorber 2 stroke, the damping fluid flows through the secondary restriction 20 in the opposite direction. In order to avoid excessive resistance, it also acts as a second check valve 22 when the preload of the second flexible shim 41 is overcome by the pressure drop and it moves away from the screw in the main member 12 and inertial element 13 assembly. This makes exposed another set of openings on the pitch circle smaller than the screw head.

The inertial effect of the mass of the main member 12 and inertial element 13 is another force participating in the force balance which derives the contact pressure of the main member 12 to static member 10. When the wheel hits an obstacle at the beginning of the compression stroke of the shock absorber 2, an acceleration acts on the unsprung mass which also includes the valve 7, in direction of suspension kinematics. The valve 7 is positioned in similar direction. The positive inertial force thus acts in the direction against the air spring 15 force.

At the moment, when the acceleration drops to zero when the wheel is rolling onto the obstacle, the speed of the shock absorber 2 stroke as well as the fluid flow is maximal and thus the secondary restriction 20 takes over the role of keeping the valve 7 opened.

At the next moment, when the wheel is rolling onto the obstacle, the acceleration is negative, thus the speed of the shock absorber 2 stroke as well as the fluid flow decrease and valve 7 closes in a controlled manner. Ideally, the mentioned mass of the inertial element 13 is so chosen, that at higher ride speeds, when there is a risk of loss of contact of the wheel with the terrain due to the inertia of the unsprung mass, the negative inertial force of the main member 12 and inertial element 13 outweighs the force from the pressure drop of the secondary restriction 20, respectively of its pressure relief valve 17, and thus the valve 7 is closing in a controlled manner.

The negative acceleration is derived from the force of the suspension, to which the force of the shock absorber 2 is added. It can lead to self-locking in the moment when the wheel bounces off the surface. The pressure in the working (compression) chamber 9 may exceed permitted limits at this time, therefore it is favourable to divide the main member 12 and the inertial element 13 and thus limit the transfer of the inertial force of inertial element 13, i.e., by a preloaded spring.

The vibration of the main member 12 is dampened by the resistance of the secondary restriction 20 and a relatively large volume of damping fluid in the area between the primary restriction 19 and the secondary restriction 20 which has to be compensated during the movement of the main member 12. Alternatively, the vibrations can be dampened by friction of the lower sliding ring between main member 12 and inertial element 13 assembly and the valve cylinder 11, which can be preloaded against the valve cylinder 11.

A sufficient ratio of axial distance between the said lower sliding ring and the sliding fit 18 to diameter of the sliding ring is crucial to keep, to prevent jamming of the slidable main member 12 in case of lateral acceleration.

The inertial effect of the damping fluid itself affects the air spring 15 so that the force from air spring 15 is higher in case of positive acceleration. This is compensated by the mass of the main member 12 and inertial element 13 assembly which acts in the opposite direction.

The effect of the fast-flowing damping fluid around the surfaces of the main member 12 just behind the primary restriction 19 produces a lower static pressure on its surfaces, resulting in a force closing the primary restriction 19. This force is compensated by the force of the secondary restriction 20 which acts in the opposite direction.

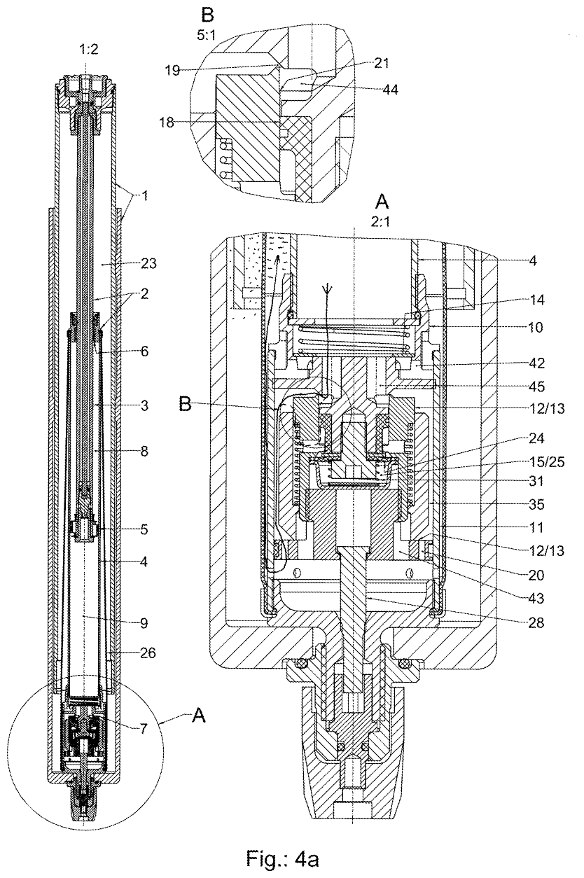

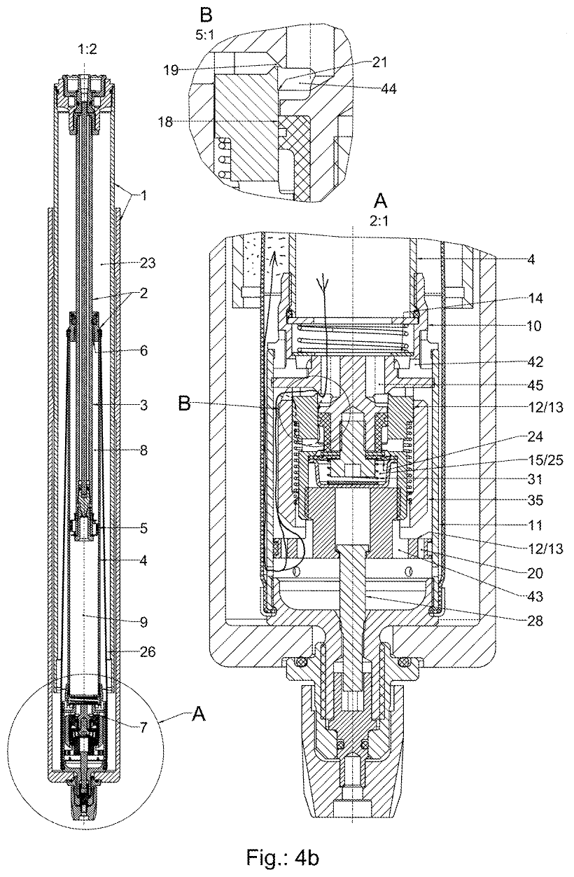

FIG. 4a-4b:

The FIG. 4a-4b show similar arrangement of the shock absorber 2 as described by FIG. 3a-3c with the following differences.

The expansion chamber 23 is located outside the shock absorber cylinders. It is formed by structural parts 1 of suspension fork legs and sealed by a membrane 26. A first check valve 14 bypassing the primary restriction 19 uses radial ports 42 in the static member 10.

Inertial element 35 is slidably attached to the main member 12, is preloaded by a spring and covers the additional ports of the high-speed secondary restriction 43 in the main member 12. Diameter of the restriction formed by the relative axial contact is larger than diameter of sliding fit between the inertial element 13 and the main member 12. Therefore, the pressure drop of the secondary restriction 20 can exert a force on the inertial element 13 acting in its closing direction by compression stroke. However, it is not a must.

Inertial element 13 can close the additional ports in the main member 12 also without the said diametrical difference so the pressure drop of the secondary restriction 20 cannot exert any force to the inertial element 13. The force is only exerted by the spring and acceleration. In such a case, when the wheel is rolling onto the obstacle and the acceleration is negative, the said spring preload will be overcome ideally only when the loss of wheel contact to the terrain is imminent. The said spring preload should be set to correspond to the force of suspension and mass of unsprung mass.

Diameter of the restriction formed by the relative axial contact of inertial element 13 to main member 12 can also be smaller than the diameter of the sliding fit between them. Therefore, the pressure drop of the secondary restriction 20 can exert a force on the inertial element 13 acting in its opening direction by compression stroke. It works then as a pressure relief valve 17 of the secondary restriction 20 which is moreover sensitive to acceleration. By negative acceleration, the setting of such pressure relief valve 17 will be softer than by positive acceleration.

External adjustment 28 can set the initial gap of the primary restriction 19.

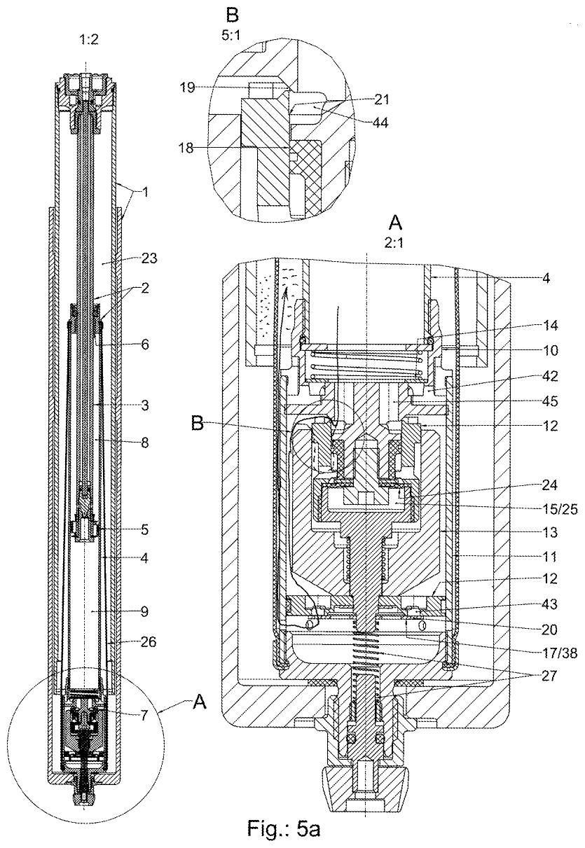

FIG. 5a-5b:

The FIG. 5a-5b shows similar arrangement of the shock absorber 2 as described by FIG. 4a-4b with following differences.

The inertial element 13 is split from main member 12 so that its force from negative acceleration is partially transmitted via spring to the main member 12 and the rest is transmitted to the static member 10.

Main member 12 is built from three parts. Two of them are screwed together to seal the air spring membrane 24 and one part, located below the inertial element 13, is secured by retaining ring. This part bears the lower sliding ring and creates the high-speed secondary restriction 43. Below this part is located one more part which covers the groove in the main member 12. This part in shape of a washer with holes is preloaded by a coil spring against the main member 12 and creates the secondary restriction 20. Said coil spring negligibly co-creates the preload of main member 12 which is mainly created by the air spring 15. External adjustment 27 of preload of the said coil spring sets the amount of damping force decrease between low-speed stroke while pedaling and mid-speed stroke while riding over an obstacle.

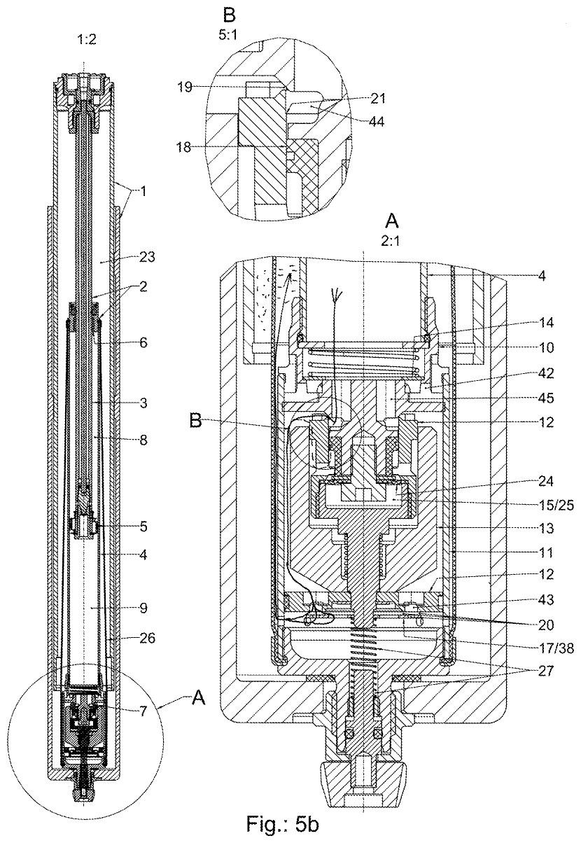

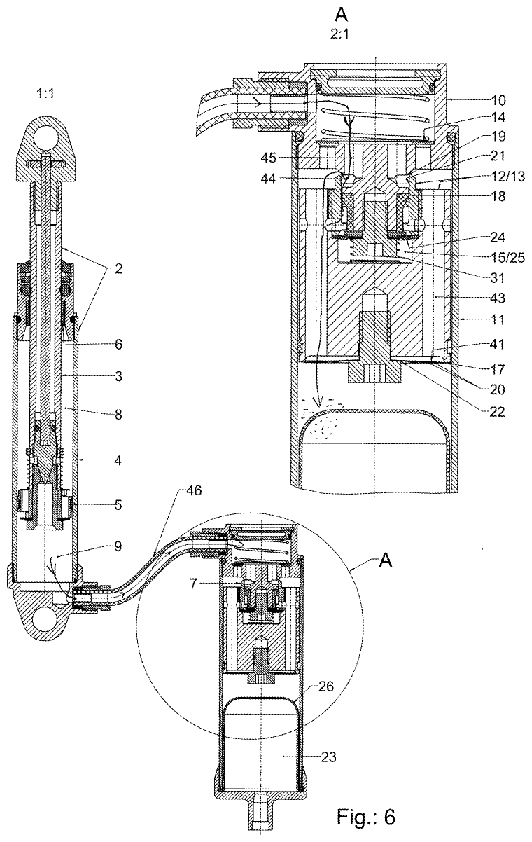

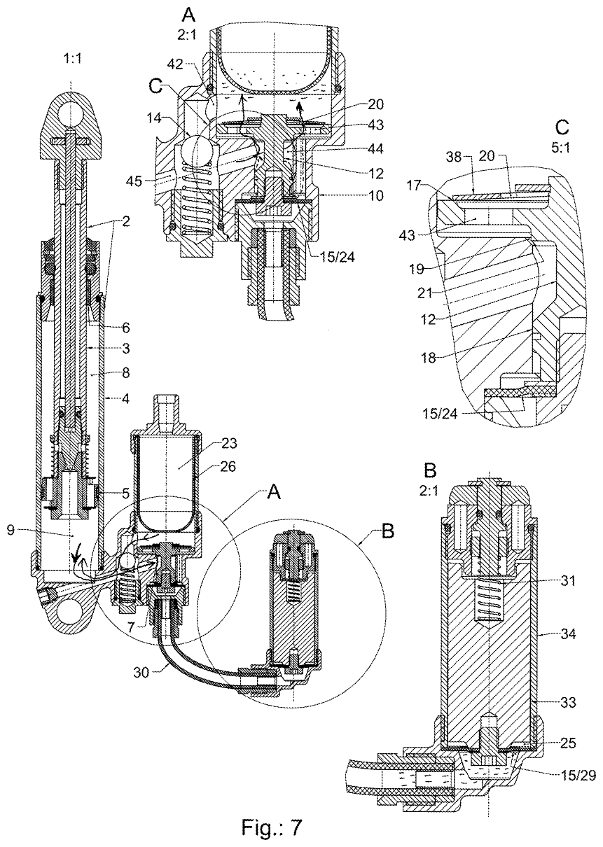

### FIG. 6:

The FIG. 6 shows similar arrangement of the shock absorber 2 as described by FIG. 3a-3c with one difference. The valve 7 assembly with the expansion chamber 23 is detached from the shock absorber 2 and connected with the working chamber 9 through a second hydraulic hose 46.

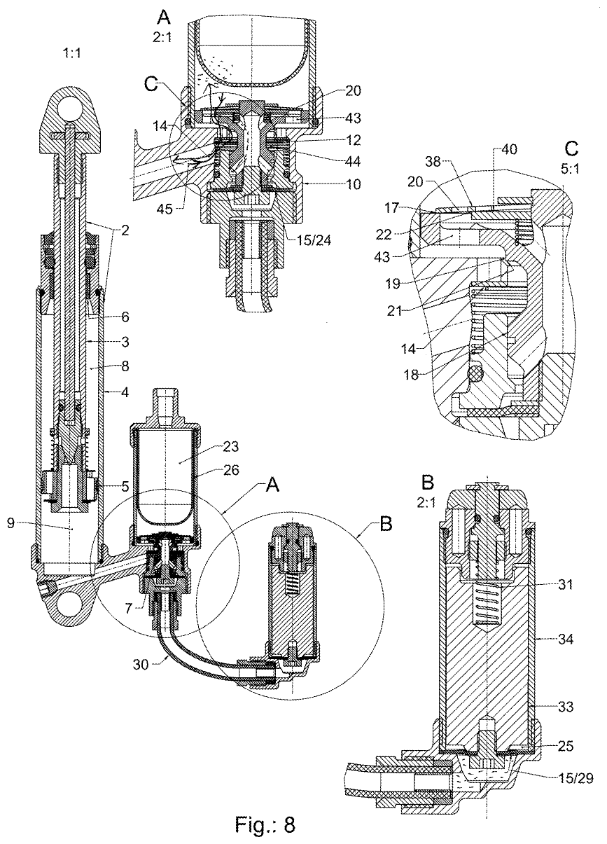

FIG. 8:

The FIG. 8 shows arrangement of the shock absorber 2 where the valve 7 with expansion chamber 23 are located at different axis from main cylinder 4 and the external inertial element 33 is employed.

Damping fluid flows from the working (compression) chamber 9 to the interspace 44 between the primary restriction 19 and the sliding fit 18 which have slightly different effective diameters. Serially connected secondary restriction 20 reduces the preload of the main member 12 to the static member 10 which is created by pressure difference between the expansion chamber 23 and atmospheric pressure in the external container 34, multiplied by a hydraulic ratio between the membrane 24 of the air spring to the external membrane 29.

The main member 12 assembly includes the secondary restriction 20, the high-speed secondary restriction 43, the pressure relief valve 17 of secondary restriction 20 and the second check valve 22. Secondary restriction 20 itself is formed by a disc spring with two sets of holes on different pitch diameters and a check valve member 40 which covers one set of the holes and is preloaded by a spring. All is secured by retaining ring. The said check valve member 40 co-creates the secondary restriction 20 in the flow direction by compression stroke. In reverse flow direction, the said check valve member 40 opens the inner set of holes. The said disc spring is preloaded by retaining ring against the main member 12 and, in case of relieving the overpressure, elastically deforms itself and opens a gap around its outer diameter.

External container 34 with external inertial element 33 is attached to unsprung mass in place and in direction where the acceleration by ride over an obstacle is greatest. External membrane 29 is sealed to the external container 34 by screwing its two parts together and to the external inertial element 33 by tightening the screw. Thereby, the external inertial element 33 can transmit its movements, inertial forces and force from the externally adjusted preload of negative spring 31, through fluid in a first hydraulic hose 30 to the membrane 24 which is sealed between two static member 10 parts and tightened to the main member 12 by screw.

Benefits of such solution are, that the first hydraulic hose 30 does not need to transmit high pressures, its elasticity does not affect the damping quality and response and the added mass onto unsprung mass is minimal.

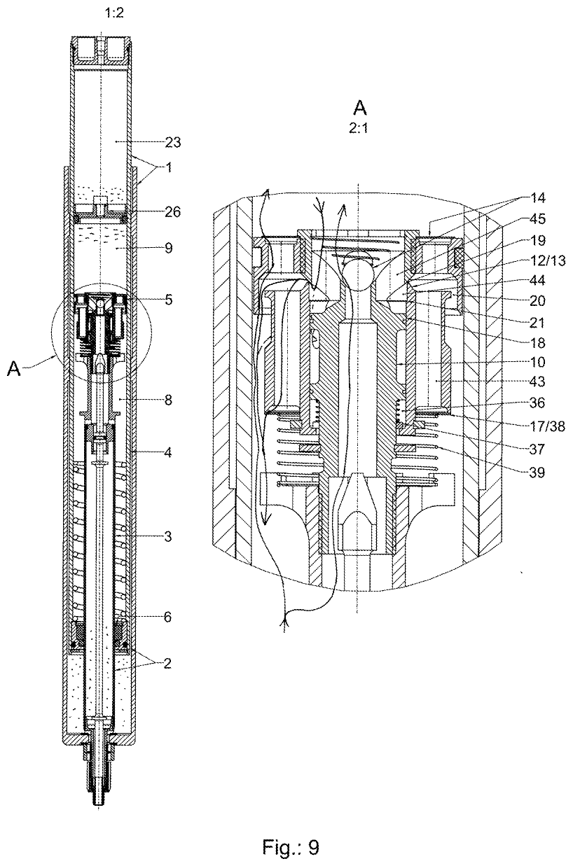

The FIG. 9 shows arrangement of the shock absorber 2 where the valve 7 is used as the main valve-located at the piston 5. The valve 7, the piston 5 and the piston rod 3 are part of the unsprung mass.

Inside the main cylinder 4, there is located damping fluid in working chamber 9, degassed at atmospheric pressure by plug 26 and then highly pressurized by Schrader valve in cap of expansion chamber 23. Such procedure should ensure that the pressure in rebound chamber 8 will be higher than atmospheric pressure during compression stroke at any conditions and that no cavities will arise in the fluid flow.

Thanks to the pressure in the expansion chamber and the cross-section of the piston rod 3, also a suspension force will be created. Only a negative coil spring is needed to relieve the preload in the beginning of the travel. Such arrangement creates a linear to degressive to progressive characteristic of the suspension force. Space in lower structural part 1 is free of fluid, only a grease is present in space between sliding rings of the structural parts 1. Air is vented through holes in bottom screw which attaches the piston rod 3 to lower structural part 1. Because of bending of structural parts 1, the attachment is slidable in radial direction so that the piston rod seal 6 and bushing will not bear excessive radial forces.

By shock absorber 2 expansion stroke, the damping fluid is pushed out from rebound chamber 8 between the piston rod 3 and the main cylinder 4, which is also a structural part 1 (upper leg of suspension fork), through the low-speed orifice, which is externally adjustable, and the high-speed shim stack on the piston 5.

By shock absorber 2 compression stroke, the damping fluid is pulled to the rebound chamber 8 through ports 45 in piston 5 to an interspace 44 between the primary restriction 19 and the sliding fit 18 between the main member 12 and the static member 10 which have different effective diameters. Said damping fluid then flows parallel through the secondary restriction 20 and the high-speed secondary restriction 43 with its pressure relief valve 17 created by a pressure relief valve member 38 which covers the ports in the main member 12. Said pressure relief valve member 38 is preloaded by a spring 39 which as well preloads the main member 12 towards the static member 10 through the said pressure relief valve member 38. This spring 39 preload is externally adjustable by screwing the static member 10 against the piston rod 3.

Pressure drop of the secondary restriction 20 creates a force onto the pressure relief valve member 38 and also onto the main member 12. It means that the pressure relief valve member 38 could create a gap only when the main member 12 hits its end stop or when a negative acceleration occurs. The said pressure drop exerts its force concentrically but a coil spring 39 with greater diameter to length ratio exerts its force with offset to its rotational axis. It means that the pressure relief valve member 38 will only lean, instead of moving, under i.e., 50% of the spring 39 force. To ensure that the force from the secondary restriction 20 pressure drop will completely relieve the primary restriction 19 preload under all conditions, it is beneficial to use a wave spring 39 instead of coil spring 39. The high-speed secondary restriction 43 helps to soften the rise of the force from negative acceleration.

Said acceleration of unsprung mass will then control the main member 12 preload and thus shock absorber 2 damping force when the wheel is rolling onto an obstacle. In case of higher riding speeds, when the wheel contact with the terrain is weaker than it should be, the damping force increases. In case of lower riding speeds over an obstacle, the damping force will be minimal. In case of movement from sprung mass i.e., pedaling, the damping force will be very high.

To avoid vibrations of the main member 12 preloaded by the spring 39, an additional damping chamber 36 is created between the main member 12 and the static member 10. By opening movement of the main member 12, a third check valve 37 enables a free flow of damping fluid into the damping chamber 36. By closing movement of the main member 12, an orifice in the third check valve 37 is used to dampen the movement. The third check valve is not a must. The damping chamber 36 can be also defined by a sliding fit and an interface defining flow resistance with different effective diameter which dampen the movements of the main member 12.

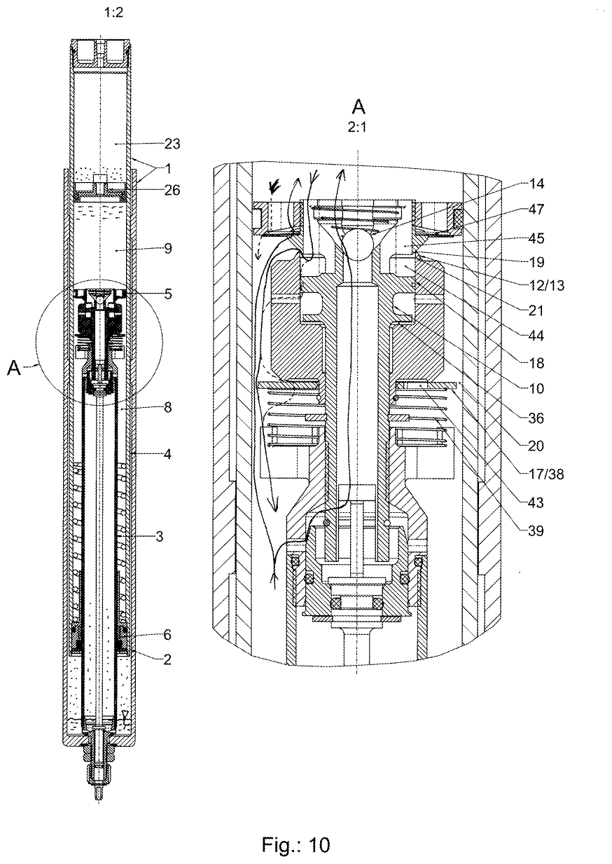

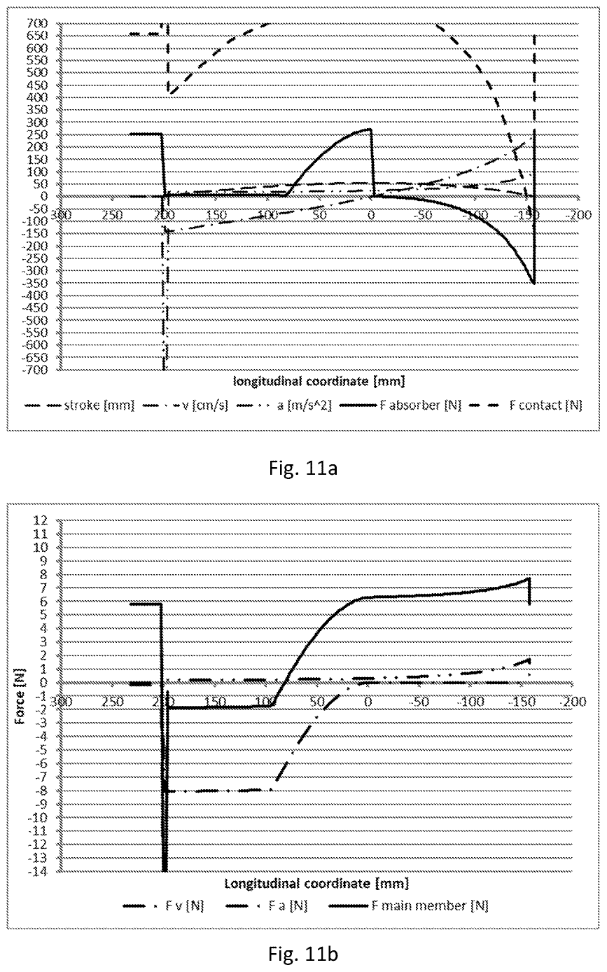

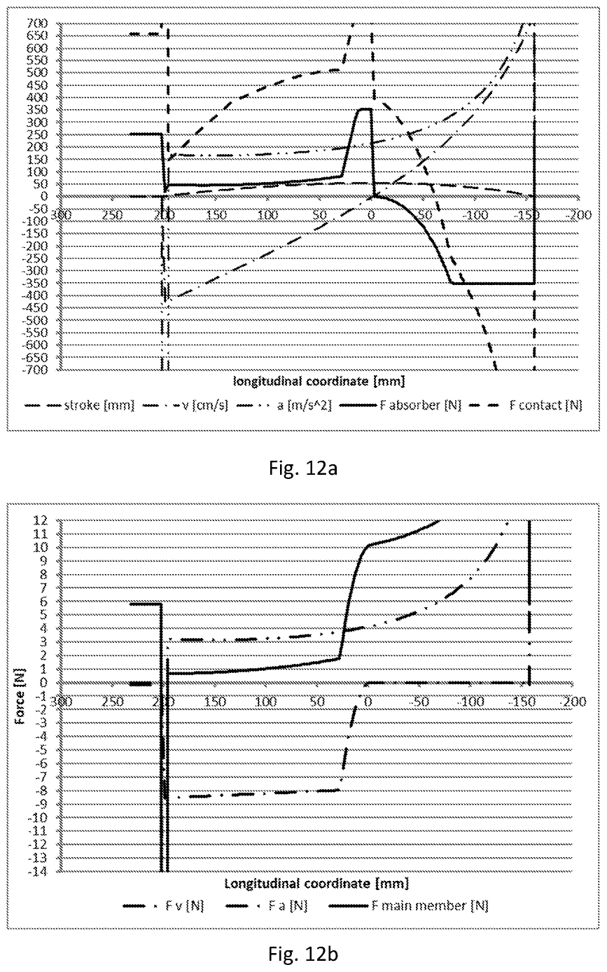

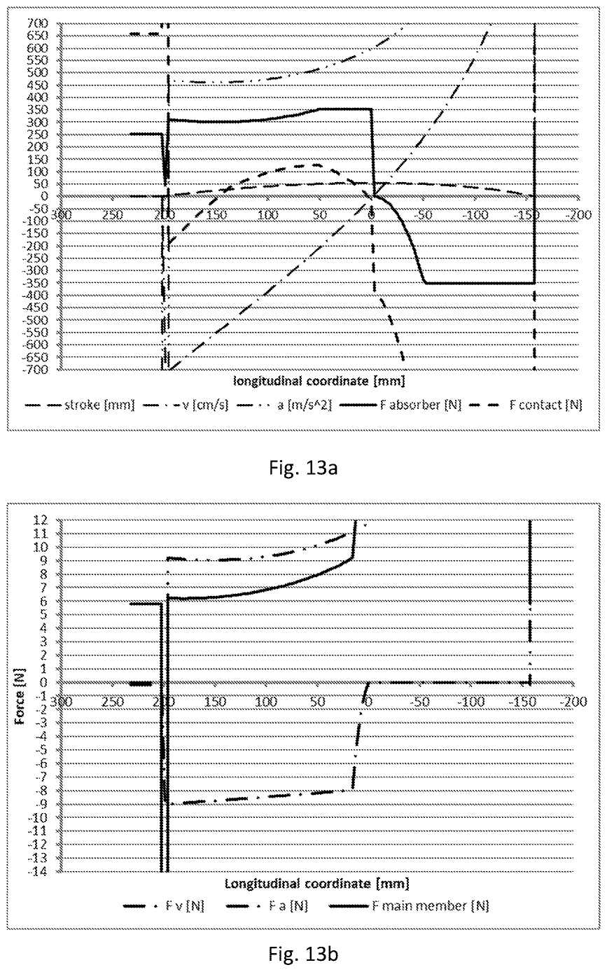

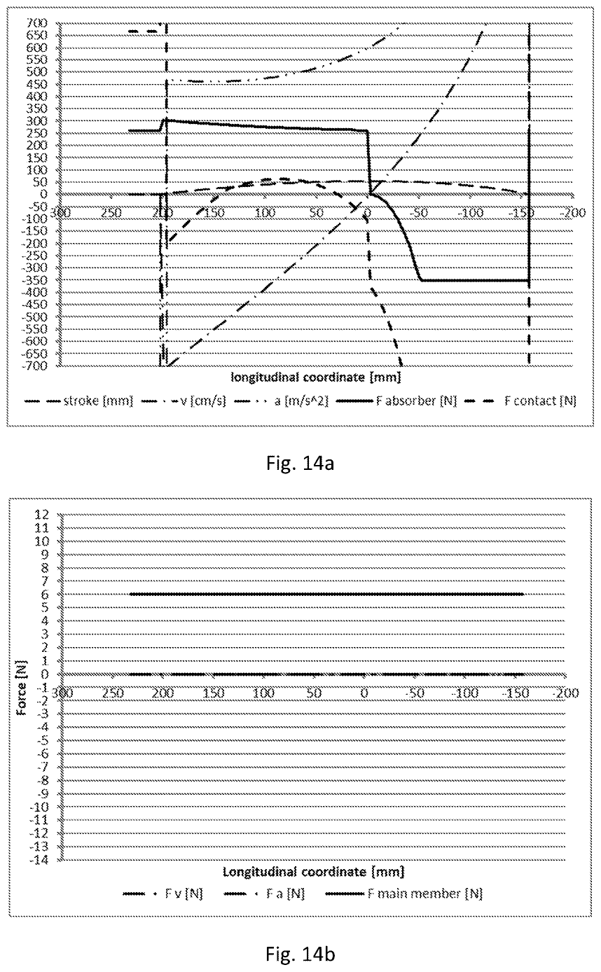

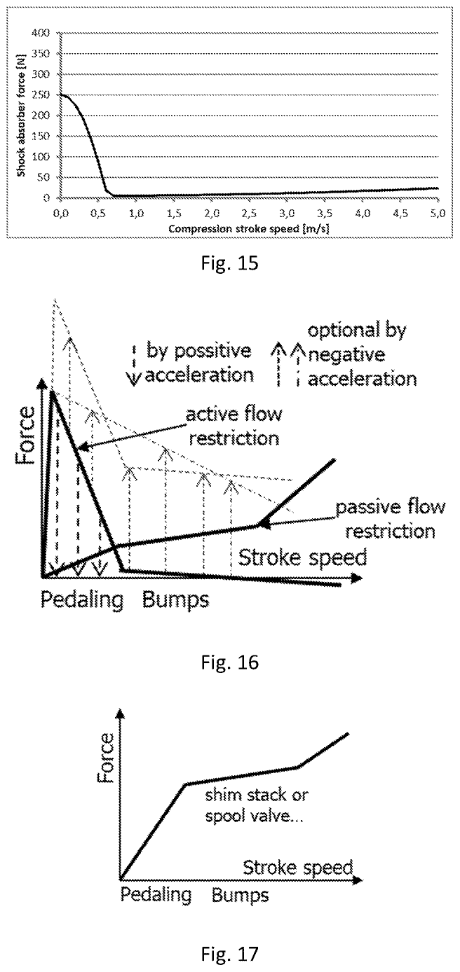

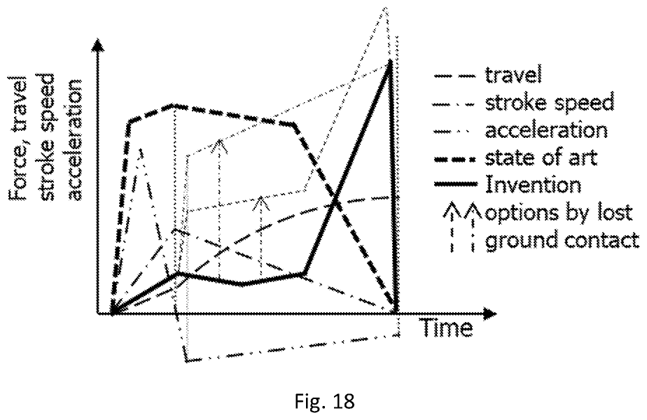

### FIG. 10:

The FIG. 10 shows similar arrangement of the shock absorber 2 as described by FIG. 9 with following differences.

Space in lower structural part 1 is not vented to the outside but through a set of holes it is merged with internal volume of piston rod 3.

The secondary restriction 20 is created by the pressure relief valve member 38 directly. The pressure drop acts on surfaces of the main member 12 and the pressure relief valve member 38 where the ratio between sizes of areas of their surfaces is approximately 1:1. To limit the force induced by the secondary restriction 20 just above the value which opens the primary restriction 19, it is preferred to use a coil spring 39 with winding diameter great enough so that its force origin is not in the center axis but radially on a half way from the center axis to the outer contact point between the pressure relief valve member 38 and the main member 12. Therefore, the pressure relief valve member 38 will rather lean than slide away. A sufficient play on its inner diameter has to be considered. Therefore, the spring 39 will be pushed under a half of its stiffness by the leaning of the pressure relief valve member 38. It is also possible to use an eccentrically positioned spring as well. The second half of the spring 39 force will be still applied to the main member 12. Oil flows through the gap in interface between the main member 12 and the pressure relief valve member 38 and further through openings on a smaller diameter in said pressure relief valve member 38 which create the high-speed secondary restriction 43.

A first flexible shim 47 creating a pressure relief valve for both flow directions is used on the piston 5. This first flexible shim 47 with openings on its inner diameter is axially preloaded between two parts of the piston 5, where the inner contact prevents the fluid to flow through the openings.

By too high pressure difference in front of and behind the piston 5, the shim 47 will elastically bend itself and lose one of its axial contacts. Therefore, it will allow the fluid to flow. Purpose is to prevent from too low pressure creating cavities in the rebound chamber 8 during compression stroke and to create a high-speed pressure relief valve to rebound damping during extension stroke of the shock absorber 2.

While this invention has been described by reference to the several embodiments, it should be understood that numerous changes could be made within the spirit and scope of the inventive concepts described above, as well as scope and fair meaning of the subjoined claims.

### LIST OF REFERENCE SYMBOLS

1 structural parts of the shock absorber-upper and lower fork legs
2 shock absorber
3 piston rod of the shock absorber
4 main cylinder of the shock absorber
5 piston of the shock absorber
6 piston rod seal
7 valve (compression valve) located as bottom valve or main valve
8 rebound chamber with damping fluid located between main cylinder and piston rod
9 working (compression) chamber with damping fluid located in cylinder
10 static member of the valve
11 cylinder of the valve
12 main member of the valve
13 inertial element of the valve
14 first check valve of the valve
15 air spring of the valve
16 mechanical spring of the valve
17 pressure relief valve of the secondary restriction of the valve
18 sliding fit—“sealing” of the primary restriction of the valve
19 primary restriction of the valve
20 secondary restriction of the valve—either low-speed stage or general
21 thin annulus—surface of the main member, where the pressure difference of damping fluid creates force
22 second check valve of the secondary restriction of the valve
23 expansion chamber of the shock absorber with air volume for compensating the volume of the piston rod
24 membrane of the air spring of the valve
25 air chamber of the air spring of the valve
26 plug or membrane of the expansion chamber of the shock absorber adjustment of preload of the pressure relief valve of the secondary restriction
27 adjustment of initial state of the primary restriction of the valve
28 external membrane of the external inertial element
29 first hydraulic hose
30 negative spring of the main member or the external inertial element
31 alternative membrane of the air spring of the valve
32 external inertial element of the valve
33 container of the external inertial element of the valve
34 inertial element, which can temporarily reduce the secondary restriction
35 damping chamber for damping the vibrations of the main member
36 third check valve of the chamber for damping the vibrations of the main member
37 pressure relief valve member of the secondary restriction
38 spring preloading the pressure relief valve at once with the main member
39 check valve member of the secondary restriction
40 second flexible shim creating the pressure relief valve and the second check valve of the secondary restriction
41 radial ports of the first check valve of the compression valve
42 high speed secondary restriction orifice or gap
43 interspace
44 port in the static member connecting the interspace with the working chamber
45 second hydraulic hose connecting the valve with the working chamber
46 first flexible shim creating a pressure relief valve for both flow directions at the piston

### LIST OF ABBREVIATIONS USED

F_{absorber}—force of the shock absorber
F_{air spr.}—force of the air spring acting on the main member of the valve
F_{neg.spr.}—force of the negative spring acting on the main member of the valve
F_{preload}—force of the mechanical spring acting on the main member of the valve
Fₐ—force induced by the acceleration acting on the main member of the valve
Fᵥ—force induced by the flow rate (stroke speed) acting on the main member of the valve
Fₚ—force induced by the pressure difference in the working (compression) chamber and the expansion chamber or the rebound chamber acting on the main member of the valve
A_{cyl.}—area of internal diameter of the main cylinder of the shock absorber
A_{p.rod}—area of external diameter of the piston rod of the shock absorber
A_{elem.}—effective area of the main member assembly of the valve, on which acts the pressure drop of the secondary restriction of the valve
A_{air spr.}—effective area of the air spring of the valve
A_{prim.restr.}—area formed by effective diameter of the primary restriction of the valve
A_{slid.fit}—area formed by effective diameter of the sliding fit of the main member of the valve
p_{comp.chamber}—pressure in the working (compression) chamber of the shock absorber
p_{exp.chamber}—pressure in the expansion chamber of the shock absorber
p_{spr.chamber}—pressure in the air spring chamber of the valve=>±atmospheric pressure
Δpₚᵢₛₜₒₙ—pressure drop of the piston of the shock absorber
Δp_{prim.restr.}—pressure drop of the primary restriction of the valve
Δp_{sek.restr.}—pressure drop of the secondary restriction of the valve
m_{elem.}—mass of the main member+the inertial element of the valve
a_{unspr.mass}—acceleration of the unsprung mass

1. Active mechanical valve for shock absorbers comprising:
a static member and a main member being slidable with respect to the static member,
wherein the main member and the static member are adapted for controlling a primary restriction,
wherein the main member is controllable at least by force of preloading member which is acting in a closing direction of the primary restriction,
wherein the main member is adapted to allow a fluid flowing through the primary restriction to pass behind the main member, when the valve is mounted in a shock absorber,
wherein the valve comprises an interspace between the static member and the main member which is adapted for communication with a working chamber of a shock absorber through at least one port in the static member with the primary restriction either open or closed,
wherein the primary restriction is an openable gap provided on an interface between the static member and the main member on a first end of the interspace,
and a sliding fit is provided on the interface between the static member and the main member on a second end of the interspace,
wherein effective cross-sectional areas of the sliding fit and the primary restriction are different and thus form an annulus,
said annulus adapted for creating a force in an opening direction of the primary restriction.

2. The active mechanical valve according to claim 1,
wherein the valve is connected to an unsprung mass of a vehicle,
wherein the main member is adapted to create, under a positive acceleration of said unsprung mass, a force acting in the opening direction of the primary restriction,
wherein the valve is a part of the shock absorber or a separate unit with a second hydraulic hose connecting the valve with the working chamber of the shock absorber.

3. The active mechanical valve according to claim 1, further comprising:
an external inertial element located in a detached container, the detached container attached to an unsprung mass of a vehicle and hydraulically connected through a first hydraulic hose to the main member,
wherein the external inertial element is adapted to create, under a positive acceleration of said unsprung mass, a force acting in the opening direction of the primary restriction,
said detached container having an external membrane between said external inertial element and the first hydraulic hose adapted to transmit inertial force and movement of said external inertial element through the fluid in the first hydraulic hose to a membrane between the first hydraulic hose and the main member.

4. The active mechanical valve according to claim 2, further comprising:
an inertial element which is slidably attached to at least one of the main member or an external inertial element so that an inertial force of the inertial element during said positive acceleration is fully transmittable to an end stop of the main member or the external inertial element and the inertial force of the inertial element during negative acceleration is either partially transmittable to the main member or the external inertial element through a spring, or completely transmittable to the static member or a detached container.

5. The active mechanical valve according to claim 1, further comprising:
a secondary restriction placed in series to the primary restriction, the secondary restriction comprising at least one gap bypassing the main member or a partition being assembled with the main member or comprising at least one orifice located in the main member or in an inertial element or in the partition being assembled with the main member or with the inertial element so that they together form a slidable main member assembly,
the secondary restriction being adapted to exert a force in the opening direction of the primary restriction against a preload of the main member,
wherein size of a greatest cross-sectional area of the slidable main member assembly is larger than size of a cross-sectional area of the annulus of the main member.

6. The active mechanical valve according to claim 5, further comprising:
a slidable inertial element being adapted to at least partially close ports of the secondary restriction by its axial contact in its end-stop with the main member.

7. The active mechanical valve according to claim 5,
wherein the secondary restriction further comprises a pressure relief valve.

8. The active mechanical valve according to claim 7,
wherein the pressure relief valve comprises a pressure relief valve member in a preloaded relative contact with at least one of the main member or the inertial element, wherein the preloaded relative contact is caused by a spring or by flexibility of the pressure relief valve member.

9. The active mechanical valve according to claim 8,
wherein the pressure relief valve member is preloaded by the spring towards the main member,
wherein a reaction of the spring is transmitted outside the main member, so that the main member is also preloaded by the force of this spring.

10. The active mechanical valve according to claim 5,
wherein the secondary restriction further comprises a second check valve.

11. The active mechanical valve according to claim 10, further comprising:
a pressure relief valve member comprising at least one additional port which is closable by a check valve member.

12. The active mechanical valve according to claim 10, further comprising:
a second flexible shim having on its first diameter at least one additional opening closable by a first relative axial contact to the main member or to the inertial element from a first side of the second flexible shim and on its second diameter a second relative axial contact to the main member or to the inertial element from a second side of the second flexible shim,
wherein the first relative axial contact and the second relative axial contact are creating axial preload of said second flexible shim so that the second flexible shim is creating a pressure relief valve in one direction and said second check valve in a reverse direction.

13. The active mechanical valve according to claim 1, further comprising:
a damping chamber formed by at least one sliding interface between the main member and the static member,
wherein the damping chamber is adapted to pump the fluid inwards and outwards upon movement of the main member through at least one orifice or a gap or a third check valve with the at least one orifice adapted to control a fluid flow.

14. The active mechanical valve according to claim 1, further comprising:
an air spring comprising an air spring chamber between the main member and the static member closed either by a flexible membrane between the main member and the static member or closed by two flexible membranes with different effective diameters between the main member and the static member,
or the air spring comprising the air spring chamber containing external inertial element, wherein the air spring chamber is closed by an external membrane and wherein the air spring is the preloading member.

15. The active mechanical valve according to claim 1, further comprising:
a first check valve or a first flexible shim placed in the static member parallel to the primary restriction,
wherein the first flexible shim has on its first diameter at least one additional opening closable by a first relative axial contact to the static member from a first side of the first flexible shim and on its second diameter a second relative axial contact to the static member from a second side of the first flexible shim,
wherein the first relative axial contact and the second relative axial contact are creating axial preload of said first flexible shim so that the first flexible shim is creating a pressure relief valve in both directions.
